(19) United States
(12) Patent Application Publication
(10) Pub. No.: US 2005/0178827 A1
(43) Pub. Date: Aug. 18, 2005

(54) Flexible fingerprint sensor arrays

(76) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/055,799

(22) Filed: Feb. 11, 2005

Related U.S. Application Data
(60) Provisional application No. 60/544,556, filed on Feb. 13, 2004.

(51) Int. Cl. G06K 5/00

(52) U.S. Cl. 235/380

(57) ABSTRACT

A print sensor, computing device, and method comprising a swipe sensor array that includes a number of sensor elements arranged in at least two columns with a gap separating each adjacent column and each sensor element in each adjacent column. Each sensor element generates signals related to a portion of a print when the print is positioned adjacent a top portion of the sensor element. When scanning, a user swipes a print perpendicular to said at least two columns, wherein each gap in a first column is overlapped by the sensor elements in the adjacent column.

### CROSS-REFERENCE TO A RELATED APPLICATION

This application for letters patent is related to and incorporates by reference provisional application Ser. No. 60/544,556, titled “Flexible Fingerprint Sensor Arrays,” and filed in the United States Patent and Trademark Office on Feb. 13, 2004.

### FIELD OF THE INVENTION

The present invention relates, in general, to biometric print scanning devices. In particular, the present invention is a fingerprint sensor constructed in an array configuration.

### BACKGROUND OF THE INVENTION

Computer security systems use biometric data, such as fingerprints, to authenticate the identity of the users attempting to gain access to a computer system. These computer systems include, but are not limited to, general-purpose computers such as desktop and portable personal computers, peripheral devices that connect to a general-purpose computer, and mobile devices such as credit cards, smart cards, cellular telephones, satellite telephones, and portable digital assistants (PDAs). A fingerprint scan in combination with a conventional means of identification, such as a password, makes a computing device that relies on these computer security systems more reliable.

The most common fingerprint sensors used on a mobile computing device are made from thin silicon chips. These silicon-based capacitive arrays are very brittle and break easily if bent. Structures to support the chip and restrict bending of the sensor contribute most of the thickness of the sensor. Pad sensors can be easily broken if bent in either the X or Y directions. Newer swipe sensors greatly reduce the possibility of bending in the X direction, but are still easily broken if bent in the Y direction.

To obtain an image of a finger, a fingerprint scanner needs to determine whether the pattern of ridges and valleys in one image matches the pattern of ridges and valleys in another image. The two most common methods for obtaining a fingerprint are optical scanning and capacitance scanning. Optical scanning uses a charge coupled device to record light and dark pixels and form an image of the fingerprint. Capacitance scanning uses electrical current to sense the image of the fingerprint. The capacitance scanner includes a number of sensors. Each sensor includes one or more semiconductor chips that contain an array of cells. Each cell includes two conductor plates covered with an insulating layer. The sensor is connected to an integrator, an electrical circuit built around an inverting operational amplifier. The conductor plates form a basic capacitor and the finger acts as a third capacitor plate. Since a variance in the distance between the capacitor plates changes the total capacitance, the capacitor in a cell under a ridge will have a greater capacitance than the capacitor in a cell under a valley.

The two most common types of capacitance scanning fingerprint sensors are pad sensors and swipe sensors. A fingerprint pad sensor is typically a small square, usually one-half inch by one-half inch in size. When a person places their finger on the pad, a form of camera or imaging devices takes a single image of the complete fingerprint. The captured image is typically digitized and stored as a digital image that can be compared to other stored images of fingerprints.

A fingerprint swipe sensor is a more recent technological development. The fingerprint swipe sensor is typically a thin, rectangular shaped device measuring approximately one-half inch by one-sixteenth inch in size. The fingerprint swipe sensor obtains a number of small images, or snapshots, as a person passes, or swipes, their finger across the sensor. The fingerprint swipe sensor obtains a complete fingerprint by processing and combining each of the individual images to form a composite image. The compiling of the smaller images into a complete fingerprint is typically referred to as “stitching” the images.

A smart card is a computing device with a size and shape that resembles a credit card. The credit card stores data on the magnetic strip affixed to the back of the credit card. In contrast, a microprocessor is embedded in the smart card and connected to a memory that can store more information than the magnetic strip affixed to the back of a credit card. The microprocessor also enables the smart card to communicate with another computer system to change and update the data stored in the memory. For example, a smart card can store a prepaid amount of money. To pay for an item at a store, the card holder presents the smart card to the merchant, scans the smart card using a reader device to determine the balance on the card, deducts the cost of the item from the balance, and stores the new balance on the smart card. However, such an exemplary smart card cannot authenticate the card holder's identity. Incorporating an authentication mechanism, such as a fingerprint scan, into this exemplary smart card would increase the reliability of smart card, but at present would significantly increase the size of the card.

Thus, there is a need for a fingerprint sensor constructed in an array configuration that reduces the possibility of breakage due to bending of the medium holding the fingerprint sensor. The present invention addresses this need.

### SUMMARY OF THE INVENTION

The present invention provides a print sensor, computing device, and method comprising a swipe sensor array that includes a number of sensor elements arranged in at least two columns with a gap separating each adjacent column and each sensor element in each adjacent column. Each sensor element generates signals related to a portion of a print when the print is positioned adjacent a top portion of the sensor element. When scanning, a user swipes a print perpendicular to said at least two columns, wherein each gap in a first column is overlapped by the sensor elements in the adjacent column.

Additional objects, advantages, and novel features of the invention will be set forth in part in the description, examples, and figures which follow, all of which are intended to be for illustrative purposes only, and not intended in any way to limit the invention, and in part will become apparent to the skilled in the art on examination of the following, or may be learned by practice of the invention.

### BRIEF DESCRIPTION OF THE DRAWINGS

The accompanying figures illustrate details of the fingerprint sensor constructed in an array configuration. Reference numbers and designations that are alike in the accompanying figures refer to like elements.

FIG. 1 is a block diagram that illustrates an exemplary embodiment of a smart card that includes a fingerprint pad sensor.

FIG. 2 is a block diagram that illustrates an exemplary embodiment of a smart card that includes a fingerprint swipe sensor.

FIG. 3 is a block diagram that illustrates an exemplary embodiment of a smart card that includes a fingerprint sensor constructed in an array configuration.

FIG. 4 is a block diagram that illustrates a cross section of the smart card shown in FIG. 3 to show three elements of the array.

### DETAILED DESCRIPTION OF THE INVENTION

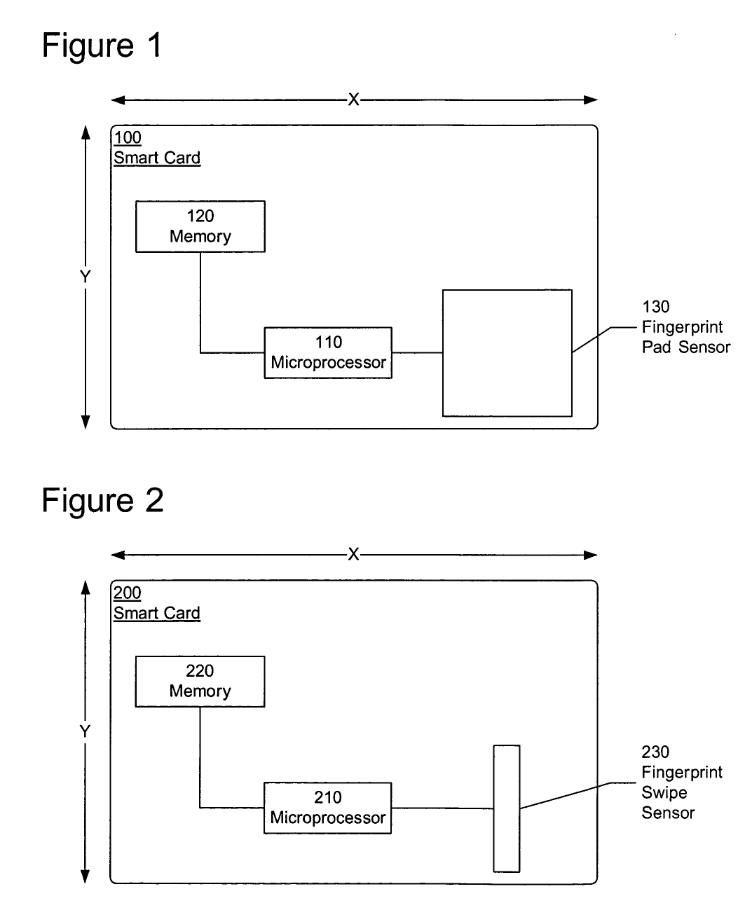

FIG. 1 illustrates an exemplary embodiment of a smart card that includes a fingerprint pad sensor. The smart card 100 comprises microprocessor 110, memory 120, and fingerprint pad sensor 130. The microprocessor 110 communicates with the memory 120 and fingerprint pad sensor 130. The microprocessor 110 receives data from the fingerprint pad sensor 130 when the card holder presses a finger on the fingerprint pad sensor 130, stores the data in memory 120, compares the data to a known fingerprint, and determines whether to authorize the card holder to use the smart card 100. The term fingerprint in the present invention is intended to include prints from any digit or area, such as a finger, thumb, palm, toe, and the like, capable of producing a unique print.

The fingerprint pad sensor 130 is a silicon-based capacitive semiconductor chip, a naturally brittle and easily breakable material. Since the material composition of the smart card 100 makes it bendable, especially when produced to confirm to credit card dimensions, the fingerprint pad sensor 130 will be susceptible to breakage in both the X and Y directions. An approach to prevent breakage of the fingerprint pad sensor 130 (i.e., reduce the bending moment) is to add (i.e., bond) a support structure layer to the back of the fingerprint pad sensor 130. The material composition of the support structure layer must be a rigid, reinforcing material, such as aluminum plate, stainless steel, or titanium. Since the fingerprint pad sensor 130 is very likely to be bent, the thickness of the reinforcing material is increased to reduce the bending moment. However, the thickness of the reinforcing material that will prevent breakage when added to the thickness of the fingerprint pad sensor 130 contributes to most of thickness of the smart card 100. Thus, this approach is not feasible in the prior art, particularly if credit card thickness is maintained.

FIG. 2 illustrates an exemplary embodiment of a smart card that includes a fingerprint swipe sensor. The smart card 200 comprises microprocessor 210, memory 220, and fingerprint swipe sensor 230. The microprocessor 210 communicates with the memory 220 and fingerprint swipe sensor 230. The microprocessor 210 receives data from the fingerprint swipe sensor 230 when the card holder passes, or swipes, a finger across the fingerprint swipe sensor 230, stores the data in memory 220, compares the data to a known fingerprint, and determines whether to authorize the card holder to use the smart card 200.

The fingerprint swipe sensor 230 is a silicon-based capacitive semiconductor chip, a naturally brittle and easily breakable material. In contrast to the fingerprint pad sensor 130, the fingerprint swipe sensor 230 is significantly narrower in the X direction, but equivalent in size in the Y direction. Since the material composition of the smart card 200 makes it inherently bendable, the fingerprint swipe sensor 230 will be susceptible to breakage, in primarily the Y direction. An approach to prevent breakage of the fingerprint swipe sensor 230 (i.e., reduce the bending moment) is to add (i.e., bond) a support structure layer to the back of the fingerprint swipe sensor 230. The material composition of the support structure layer must be a rigid, reinforcing material, such as aluminum plate, stainless steel, titanium, or other rigid sheet-like material. However, for the reasons stated with regard to the print pad sensor 130, the fingerprint swipe sensor 230 is also very likely to bend. Consequently, in the prior art the thickness of the reinforcing material is increased to reduce the bending moment. Unfortunately, the thickness of the reinforcing material needed to prevent breakage of the fingerprint swipe sensor 230 contributes substantially to the thickness of the smart card 200, making this approach is not feasible if credit card thickness is maintained.

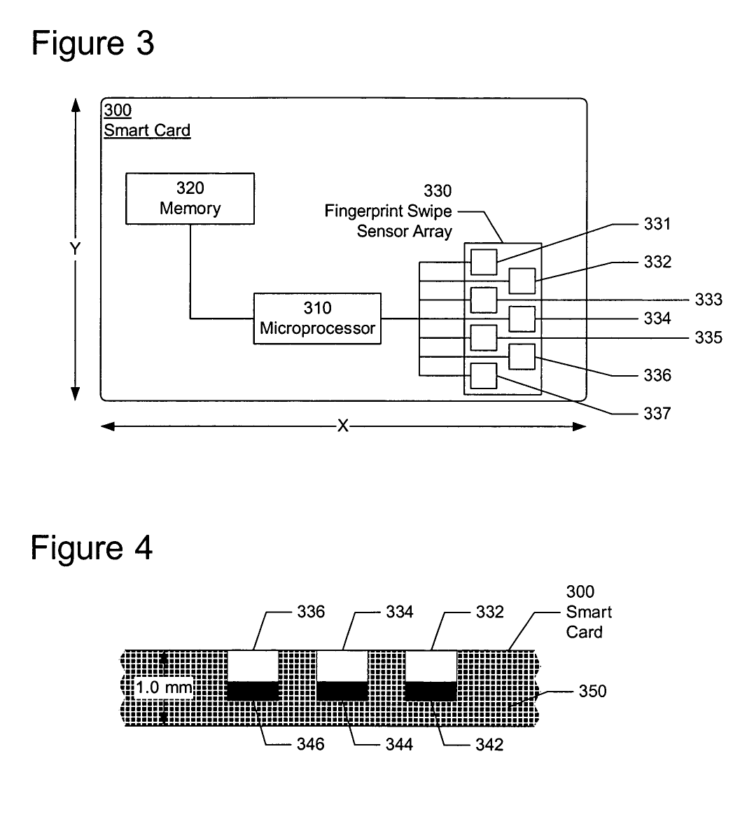

FIG. 3 illustrates an exemplary embodiment of a smart card that includes a fingerprint sensor constructed in an array configuration. The smart card 300 comprises microprocessor 310, memory 320, and fingerprint swipe sensor array 330. The fingerprint swipe sensor array 330 comprises a plurality of fingerprint swipe sensor elements 331, 332, 333, 334, 335, 336, 337. The microprocessor 310 communicates with the memory 320 and each fingerprint swipe sensor element 331, 332, 333, 334, 335, 336, 337 in the fingerprint swipe sensor array 330. The microprocessor 310 receives data from the fingerprint swipe sensor array 330 when the card holder swipes a finger across the fingerprint swipe sensor elements 331, 332, 333, 334, 335, 336, 337, stores the data in memory 320, compares the data to a known fingerprint, and determines whether to authorize the card holder to use the smart card 300.

Each fingerprint swipe sensor element 331, 332, 333, 334, 335, 336, 337 is a silicon-based capacitive semiconductor chip, a naturally brittle and easily breakable material. In an exemplary embodiment, each element of measures approximately one-sixteenth inch by one-sixteenth inch in size. However, for the same reason the fingerprint swipe sensor 230 shown in FIG. 2 was less likely to break in the X direction than the fingerprint pad sensor 130 shown in FIG. 1, each fingerprint swipe sensor element 331, 332, 333, 334, 335, 336, 337 is less likely to break in both the X and the Y directions. Since, as noted above, the material composition of the smart card 300 makes it bendable, each fingerprint swipe sensor element 331, 332, 333, 334, 335, 336, 337 will also be minimally susceptible to breakage in both the X and Y directions. Furthermore, since the fingerprint swipe sensor elements 331, 332, 333, 334, 335, 336, 337 are embedded in the smart card 300, the smart card 300 fabrication material fills in the gaps between the adjacent columns of elements and between the swipe sensor elements in each column. Since this fabrication material is bendable, it absorbs some physical stresses that would otherwise transfer to the fingerprint swipe sensor elements 331, 332, 333, 334, 335, 336, 337.

An approach to prevent breakage of each fingerprint swipe sensor element 331, 332, 333, 334, 335, 336, 337 (i.e., reduce the bending moment) is to add (i.e., bond) a support structure layer to the back of each fingerprint swipe sensor element 331, 332, 333, 334, 335, 336, 337. The material composition of the support structure layer must be a rigid, reinforcing material, such as aluminum plate, stainless steel, titanium, or other rigid sheet-like material. Since the length of each fingerprint swipe sensor element 331, 332, 333, 334, 335, 336, 337 is narrow in both the X and Y directions, each supported element is less likely to bend. Thus, the thickness of the reinforcing material to reduce the bending moment is significantly less than the thickness required for the fingerprint pad sensor 130 and the fingerprint swipe sensor 230.

Small silicon-based capacitive semiconductor chips used in fingerprint sensors are cut from very large silicon disks. A single flaw in a large chip will force rejection of the whole chip and reduce the yield of the wafer. Reducing the size of the chip will not reduce the number of flaws, but it will reduce the amount of rejected material and improve the overall yield of the wafer.

The fingerprint swipe sensor array 330 is constructed from a number of overlapping small chips, fingerprint swipe sensor elements 331, 332, 333, 334, 335, 336, 337, to reduce the possibility of breakage due to bending and to improve the yield in manufacturing the chips. This array of chips will require additional assembly, which will be easily offset by the production of thinner and more durable sensors. These sensors will be ideal for use in smart cards where a limited amount of bending of the card is permitted and is a requirement of the smart card specification. The array can be constructed, and software designed, such that damage to any chip in the array does not adversely affect the ability to obtain a workable fingerprint image. Another advantage of the fingerprint sensor array 330 is that most of the stress applied to the each small chip, fingerprint swipe sensor elements 331, 332, 333, 334, 335, 336, 337, due to card bending can be absorbed in the plastic matrix surrounding the chips.

FIG. 4 is a block diagram that illustrates a cross section of the smart card shown in FIG. 3 to show three elements of the array. The material composition of the smart card 300 comprises a plastic matrix 350, such as a polymer, polycarbonate, polyvinylchloride (PVC), polyester (PET), or similar material. In the exemplary embodiment shown in FIG. 4, the plastic matrix measures approximately 1.0 millimeter in thickness. In a preferred embodiment it does not exceed the accepted thickness of a credit card read by a swipe device. The plastic matrix 350 holds each fingerprint swipe sensor element 331, 332, 333, 334, 335, 336, 337 in place, fills in the gaps between the adjacent columns of elements and between the swipe sensor elements in each column, and functions to absorb bending of the card in the spaces between the individual elements of the array.

FIG. 4 shows a subset of the fingerprint swipe sensor array 330, fingerprint swipe sensor elements 332, 334, 336 is bonded to a bending support 342, 344, 346. In the exemplary embodiment shown in FIG. 4, the thickness of each fingerprint swipe sensor element 332, 334, 336 measures approximately 0.28 millimeters, and the thickness of each bending support 342, 344, 346 measures approximately 0.36 millimeters. While the individual and combined thickness of sensor element and bending support is variable, in at least one preferred embodiment the thickness will not exceed the standard credit card thickness of smart card 300. In the alternative, such a thickness limitation is not essential for use of the present invention in applications, such a as cell phone or PDA, in which the flexibility of the sensor will make it more durable. The size of the gap between the fingerprint swipe sensor elements 332, 334, 336 is variable, but will not exceed the width of an individual fingerprint swipe sensor element.

Although the disclosed embodiments describe a fully functioning fingerprint sensor constructed in an array configuration, the reader should understand that other equivalent embodiments exist. Since numerous modifications and variations will occur to those reviewing this disclosure, the fingerprint sensor constructed in an array configuration is not limited to the exact construction and operation illustrated and disclosed. Accordingly, this disclosure intends all suitable modifications and equivalents to fall within the scope of the claims.

1. A print sensor, comprising:
a swipe sensor array that includes a number of sensor elements arranged in at least two columns with a gap separating each adjacent column and each sensor element in each adjacent column,
wherein, when scanning, a user swipes a print perpendicular to said at least two columns, each gap in a first column is overlapped by the sensor elements in the adjacent column, and
wherein each sensor element generates signals related to a portion of a print when the print is positioned adjacent a top portion of the sensor element.

2. The print sensor of claim 1, wherein each sensor element is a silicon-based capacitive semiconductor chip.

3. The print sensor of claim 1, wherein the swipe sensor array lays in a plastic matrix.

4. The print sensor of claim 3, wherein the plastic matrix is selected from the group consisting of a polymeric, polycarbonate, polyvinylchloride (PVC), polyester (PET), or similar material.

5. The print sensor of claim 3, wherein the plastic matrix provides the gap separating each adjacent column and each sensor element in each adjacent column.

6. The print sensor of claim 3, each sensor element further comprising a reinforcing layer attached to a bottom portion of each sensor element.

7. The print sensor of claim 3, wherein the reinforcing layer is a thin layer of at least one rigid material selected from the group consisting of aluminum plate, stainless steel, titanium, or other lightweight rigid material.

8. The print sensor of claim 3, wherein the plastic matrix is of standard credit card size and thickness.

9. The print sensor of claim 1, wherein the print includes prints from any digit or area, such as a finger, thumb, palm, toe, and the like, capable of producing a unique print.

10. A computing device, comprising:
a processor;
a memory disposed in communication with the processor;
a swipe sensor array disposed in communication with the processor, the sensor array including a number of sensor elements arranged in at least two columns with a gap separating each adjacent column and each sensor element in each adjacent column,
wherein, when scanning, a user swipes a print perpendicular to said at least two columns, each gap in a first column is overlapped by the sensor elements in the adjacent column, and
wherein each sensor element generates signals related to a portion of a print when the print is positioned adjacent a top portion of the sensor element.

11. The computing device of claim 10, wherein each sensor element is a silicon-based capacitive semiconductor chip.

12. The computing device of claim 10, wherein the swipe sensor array lays in a plastic matrix.

13. The computing device of claim 12, wherein the plastic matrix is selected from the group consisting of a polymeric, polycarbonate, polyvinylchloride (PVC), polyester (PET), or similar material.

14. The computing device of claim 12, wherein the plastic matrix provides the gap separating each adjacent column and each sensor element in each adjacent column.

15. The computing device of claim 12, each sensor element further comprising a reinforcing layer attached to a bottom portion of each sensor element.

16. The computing device of claim 12, wherein the reinforcing layer is a thin layer of at least one rigid material selected from the group consisting of aluminum plate, stainless steel, titanium, or other lightweight rigid material.

17. The computing device of claim 12, wherein the plastic matrix is of standard credit card size and thickness.

18. The computing device of claim 10, wherein the print includes prints from any digit or area, such as a finger, thumb, palm, toe, and the like, capable of producing a unique print.

19. A method of capturing a print image, comprising:
providing a number of sensor elements arranged in at least two columns with a gap separating each adjacent column and each sensor element in each adjacent column,
generating signals from each sensor element related to a portion of the print when the print is positioned adjacent a top portion of the sensor element,
wherein, when scanning, a user swipes a print perpendicular to said at least two columns, each gap in a first column is overlapped by the sensor elements in the adjacent column.

20. The method of claim 17, further comprising attaching a reinforcing layer to the bottom portion of each sensor element.
